(19) United States
(12) Patent Application Publication
(10) Pub. No.: US 2020/0022220 A1
(43) Pub. Date: Jan. 16, 2020

(54) INFORMATION TRANSMISSION METHOD, PROCESSING METHOD, AND APPARATUS

(71) Applicant: HUAWEI TECHNOLOGIES CO., LTD., Shenzhen (CN)

(72) Inventors: Xinqian XIE, Beijing (CN); Zhiheng GUO, Beijing (CN); Sha MA, Beijing (CN); Wei SUN, Shenzhen (CN)

(21) Appl. No.: 16/579,314

(22) Filed: Sep. 23, 2019

Related U.S. Application Data
(63) Continuation of application No. PCT/CN2018/079521, filed on Mar. 20, 2018.

(30) Foreign Application Priority Data
Mar. 24, 2017 (CN) 201710182194.5

(51) Int. Cl. H04W 92/10; H04W 72/04; H04W 72/12; H04W 72/08

(52) U.S. Cl. CPC H04W 92/10; H04W 72/082; H04W 72/121; H04W 72/0446

(57) ABSTRACT

This application provides an information transmission method. The method includes: determining, by a first network device, a communication type of the first network device in a second time period; and sending, by the first network device, a signal to a second network device in a first time period through an air interface when the communication type is downlink communication or an idle communication type, where the signal is used to indicate the communication type. The second network device may use the received information on the communication type of the first network device in the second time period to determine its communication type in the second time period to minimize interference between the two network devices. For example, if the communication type of the first network device is downlink in the second time period, the second network device may determine its communication type to be downlink in the second time period.

### CROSS-REFERENCE TO RELATED APPLICATIONS

This application is a continuation of International Application No. PCT/CN2018/079521, filed on Mar. 20, 2018, which claims priority to Chinese Patent Application No. 201710182194.5, filed on Mar. 24, 2017. The disclosures of the aforementioned applications are hereby incorporated by reference in their entireties.

### TECHNICAL FIELD

This application relates to the field of wireless communications technologies, and specifically, to an information transmission method, a processing method, and an apparatus.

### BACKGROUND

In a wireless communications system, there are two different duplex modes: time division duplex (TDD) and frequency division duplex (FDD). In a TDD mode, a communications system usually has only one operating frequency band, and the operating frequency band is used only for uplink communication or downlink communication in a time period. Such an operating frequency band is usually referred to as an unpaired operating frequency band. In an FDD mode, a communications system has two paired operating frequency bands: One operating frequency band is used only for uplink communication, and the other operating frequency band is used only for downlink communication.

Because terminal devices are unevenly distributed in a communications network, there may be different quantities of terminals in coverage areas of different network devices, and the terminal devices may differ greatly in uplink/downlink traffic volume in a same time period. Consequently, there may be a relatively large difference between uplink/downlink traffic volumes of the different network devices in the same time period. In an existing TDD mode, different network devices need to use a same communication type on an operating frequency band in a same time period. In an existing FDD mode, different network devices also need to use a same communication type on any one of paired operating frequency bands in a same time period. Using the same communication type herein means that different network devices simultaneously perform uplink communication or downlink communication. With this configuration method, an actual requirement, on an uplink/downlink traffic volume, of a terminal device in a coverage area of each network device cannot be met. Therefore, a more flexible duplex technology is introduced. To be specific, a communication type of each cell may be configured based on an actual service requirement. For example, in a communications network in the TDD mode, uplink communication or downlink communication may be performed in each time period. In a communications network in the FDD mode, downlink communication may be performed by using an uplink frequency band in a time period. For ease of description, this duplex technology is referred to as a flexible duplex technology.

Transmit power of a network device is far greater than transmit power of a terminal device. Therefore, the following communication scenario usually occurs in a communications network in which the flexible duplex technology is used: When one network device performs uplink communication with a terminal device in a coverage area of the network device, one or more network devices that are geographically relatively close to the network device are performing downlink communication with a terminal device in a coverage area of the one or more network devices. When receiving an uplink signal, the network device that is performing uplink communication may be seriously interfered with by a downlink signal sent by another network device that is geographically relatively close to the network device and that is performing downlink communication. If two network devices respectively perform uplink signal transmission and downlink signal transmission by using a same operating frequency band, interference caused by transmission of a downlink signal on receiving of an uplink signal is stronger. For example, in the TDD mode, because there is only one operating frequency band, the co-channel interference problem inevitably occurs. In the FDD mode, if a network device performs downlink transmission by using an uplink frequency band, the co-channel interference problem also occurs between the network device and another network device that performs uplink transmission normally by using the uplink frequency band.

To resolve this technical problem, an interfered network device usually may use an interference cancellation technology to cancel interference that is caused by a network device that is geographically relatively close to the interfered network device. However, in an actual network, there are usually a plurality of neighboring cells near one cell. In this case, performance of the interference cancellation technology is sharply degraded, and even normal operation of the network cannot be ensured.

Therefore, other solutions use an interference coordination technology. In the interference coordination technology, a plurality of network devices that are geographically relatively close to each other notify each other of their respective communication types in some time periods, so that some network devices that intend to perform uplink communication can change communication types of the network devices when learning that a plurality of network devices that are relatively close to the network devices intend to perform downlink communication, to avoid interference of a neighboring cell to the network devices. It can be learned that network devices need to mutually exchange their respective communication types, so that the interference coordination technology can be used.

Network devices may send communication types to each other by using a wired technology. The data throughput in a wired interface may be relatively low. For example, it may take 20 ms to send and receive a communication type. Consequently, there is a relatively high communication type transmission delay between network devices, and interference coordination may fail to be performed between the network devices in a timely manner based on communication types of the adjacent network devices.

### SUMMARY

In view of this, this application provides an information transmission method and a processing method, so that a network device can learn a communication type of an adjacent network device in a timely manner.

According to a first aspect, this application provides an information transmission method, and the method includes:

determining, by a first network device, a communication type of the first network device in a second time period; and

sending, by the first network device, a signal to a second network device in a first time period through an air interface when the communication type is downlink communication or an idle communication type, where the signal is used to indicate the communication type.

In this embodiment of this application, the first network device determines the communication type in the second time period, and when the communication type is the downlink communication or the idle communication type, the first network device sends, to the second network device in the first time period through the air interface, the signal used to indicate the communication type, so that the first network device needs to send information about only two communication types, thereby saving a resource of the first network device. In addition, the second network device may quickly learn the communication type of the first network device in the second time period by listening to the signal, so that the second network device can perform interference coordination in a timely manner based on the communication type of the first network device in the second time period.

The determining, by a first network device, a communication type of the first network device in a second time period may specifically include:

determining, by the first network device, the communication type of the first network device in the second time period based on a service of the first network device in the second time period.

The method may further include:

sending, by the first network device, indication information to a terminal device, where the indication information is used to indicate the communication type, and the communication type herein may be uplink communication, the downlink communication, or the idle communication type; or sending the indication information only when the communication type is uplink communication, where the indication information indicates that the communication type is the uplink communication.

According to a second aspect, this application provides a processing method, and the method includes:

listening to, by a second network device in a first time period through an air interface, a signal sent by a first network device, where the signal is used to indicate that a communication type of the first network device in a second time period is downlink communication or an idle communication type; and if the second network device receives the signal, determining, based on the signal, that the communication type of the first network device in the second time period is the downlink communication or the idle communication type.

In this embodiment of this application, the second network device quickly learns of the communication type of the first network device in the second time period by listening to, in the first time period, the signal that is sent by the first network device and that is used to indicate that the communication type of the first network device in the second time period is the downlink communication or the idle communication type, so that the second network device can perform interference coordination in a timely manner based on the communication type of the first network device in the second time period.

The method may further include:

if the second network device does not receive the signal, determining that the communication type of the first network device in the second time period is uplink communication.

In this manner, the first network device needs to send only two communication types. Therefore, a communication resource of the first network device can be saved.

Alternatively, the method may further include:

listening to, by the second network device in the first time period, an uplink signal sent by a terminal device managed by the first network device; and

if the second network device does not receive the signal sent by the first network device, but receives the uplink signal, determining that the communication type of the first network device in the second time period is uplink communication; or

if the second network device receives the uplink signal, determining that the communication type of the first network device in the second time period is uplink communication.

In this manner, a communication resource of the first network device can be saved, and the second network device can more accurately determine the communication type of the first network device by using the uplink signal.

After determining the communication type of the first network device in the second time period, the second network device may further determine a communication type of the second network device in the second time period.

For example, after determining that the communication type of the first network device in the second time period is the uplink communication, the second network device determines that the communication type of the second network device in the second time period is the uplink communication, power-reduced downlink communication, or the idle communication type.

After determining that the communication type of the first network device in the second time period is the downlink communication, the second network device determines that the communication type of the second network device in the second time period is the downlink communication or the idle communication type.

After determining that the communication type of the first network device in the second time period is the idle communication type, the second network device determines that the communication type of the second network device in the second time period is the uplink communication, the downlink communication, or the idle communication type.

In addition, when determining the communication type, the second network device may further consider a current traffic volume of the second network device.

In the foregoing manner, the second network device may determine the communication type of the second network device based on the communication type of the first network device, so that interference of communication of the second network device to the first network device can be avoided as much as possible, and a communication effect of the first network device is preferentially ensured.

According to a third aspect, an embodiment of this application further provides an information transmission method, and the method includes:

obtaining, by a terminal device, information about communication types between a first network device and the terminal device in a first time period and a second time period; and

sending, by the terminal device, an uplink signal to the first network device in the first time period when the communication types are uplink communication.

In this embodiment of this application, the terminal device sends the uplink signal to the first network device when the communication types between the first network device and the terminal device in the first time period and the second time period are the uplink communication, so that a second network device adjacent to the first network device can receive the uplink signal, and can accurately determine, based on the uplink signal, whether the communication type of the first network device in the second time period is the uplink communication.

The terminal device may obtain the information about the communication types between the first network device and the terminal device in the first time period and the second time period in a plurality of embodiments.

For example, an embodiment may be as follows:

The terminal device receives indication information from the first network device, where the indication information is used to indicate the communication types; and

correspondingly, before the sending, by the terminal device, an uplink signal to the first network device in the first time period, the method further includes: determining, by the terminal device based on the indication information, whether the communication types are the uplink communication.

Another embodiment may be as follows:

The terminal device receives indication information from the first network device, where the indication information is used to indicate that the communication types are the uplink communication; and

the sending, by the terminal device, an uplink signal to the first network device in the first time period when the communication types are uplink communication includes:

sending, by the terminal device, the uplink signal to the first network device in the first time period after receiving the indication information.

Optionally, in some embodiments of this application, a signal sent by the first network device to the second network device may be a pilot signal, a control signal, or a data signal. Sending is implicitly performed by using the pilot signal, the control signal, or the data signal, so that the first network device does not need to reserve a time resource for sending the signal. Therefore, the time resource of the first network device can be saved.

Network devices in some embodiments of this application may belong to different groups. For example, the first network device belongs to a first group of network devices, and the second network device belongs to a second group of network devices. Each network device in the first group of network devices sends information about a communication type of each network device only to the second group of network devices, and does not listen to information about a communication type of another network device.

The second group of network devices need to listen to information about communication types of the first group of network devices, and do not send information about communication types of the second group of network devices to the first group of network devices.

In this grouping manner, a priority of the first group of network devices can be higher than a priority of the second group of network devices. The first group of network devices need to determine the communication types based only on services of the first group of network devices without considering the communication types of the second group of network devices, and the second group of network devices need to determine the communication types of the second group of network devices based on the communication types of the first group of network devices, so that interference to the first group of network devices is minimized.

In a same time period, the first network device and the second network device may differ in communication type on a same frequency band.

The first time period may be before the second time period; or the second time period includes the first time period, and the first time period is a start time of the second time period.

According to a fourth aspect, this application provides a network device, configured to perform the method in any one of the first aspect or the possible embodiments of the first aspect. Specifically, the network device may include a unit configured to perform the method in any one of the first aspect or the possible embodiments of the first aspect. For example, the network device may include a processing unit and a sending unit.

According to a fifth aspect, this application provides a network device, configured to perform the method in any one of the second aspect or the possible embodiments of the second aspect. Specifically, the network device may include a unit configured to perform the method in any one of the second aspect or the possible embodiments of the second aspect. For example, the network device may include a receiving unit and a processing unit.

According to a sixth aspect, this application provides a terminal device, configured to perform the method in any one of the third aspect or the possible embodiments of the third aspect. Specifically, the terminal device may include a unit configured to perform the method in any one of the third aspect or the possible embodiments of the third aspect. For example, the terminal device may include a receiving unit, a sending unit, and a processing unit.

According to a seventh aspect, this application provides a network device. The network device includes one or more processors, one or more memories, and one or more transceivers. Each transceiver may include a transmitter and a receiver. The transmitter or the receiver is connected to one or more antennas, and receives and sends a signal through the antenna. The memory is configured to store a computer program instruction or code. The processor is configured to execute the instruction stored in the memory; and when the instruction is executed, the processor performs the method in any one of the first aspect or the possible embodiments of the first aspect.

According to an eighth aspect, this application provides a network device. The network device includes one or more processors, one or more memories, and one or more transceivers. Each transceiver may include a transmitter and a receiver. The transmitter or the receiver is connected to one or more antennas, and receives and sends a signal through the antenna. The memory is configured to store a computer program instruction or code. The processor is configured to execute the instruction stored in the memory; and when the instruction is executed, the processor performs the method in any one of the second aspect or the possible embodiments of the second aspect.

According to a ninth aspect, this application provides a terminal device. The terminal device includes one or more processors, one or more memories, and one or more transceivers. Each transceiver may include a transmitter and a receiver. The transmitter or the receiver is connected to one or more antennas, and receives and sends a signal through the antenna. The memory is configured to store a computer program instruction or code. The processor is configured to execute the instruction stored in the memory; and when the instruction is executed, the processor performs the method in any one of the third aspect or the possible embodiments of the third aspect.

According to a tenth aspect, this application provides a wireless communications system. The wireless communications system includes the foregoing first network device and second network device.

According to an eleventh aspect, this application provides a computer readable storage medium. The computer readable storage medium stores an instruction; and when the instruction runs on a computer, the computer performs the method in any one of the first aspect or the possible embodiments of the first aspect.

According to a twelfth aspect, this application provides a computer readable storage medium. The computer readable storage medium stores an instruction; and when the instruction runs on a computer, the computer performs the method in any one of the second aspect or the possible embodiments of the second aspect.

According to a thirteenth aspect, this application provides a computer readable storage medium. The computer readable storage medium stores an instruction; and when the instruction runs on a computer, the computer performs the method in any one of the third aspect or the possible embodiments of the third aspect.

### BRIEF DESCRIPTION OF DRAWINGS

FIG. 1 is a flowchart according to an embodiment of this application;

FIG. 2 is a block diagram of a first network device according to an embodiment of this application;

FIG. 3 is a block diagram of a second network device according to an embodiment of this application; and

FIG. 4 is a block diagram of a terminal device according to an embodiment of this application.

### DESCRIPTION OF EMBODIMENTS

Network devices may send communication types to each other in a wired interface; and because of a relatively high delay, interference coordination may fail to be performed between the network devices in a timely manner based on communication types of the adjacent network devices. Therefore, a communication type may be sent in a wireless interface. For example, network devices may send communication types to each other through an air interface.

In a possible embodiment, each network device determines that a communication type is uplink communication or downlink communication, and then sends the communication type to another network device through an air interface. Correspondingly, the other network device determines, based on a received signal, that the communication type is the uplink communication or the downlink communication. Other embodiments are possible. The following describes these specific embodiments in detail.

In the foregoing embodiment, two communication types are mainly considered: the uplink communication and the downlink communication. To enable a network device to use a resource as fully as possible, an idle communication type may be further added. In addition, to minimize resources occupied by a network device to send a communication type, the network device may send only two of the three communication types, and another network device may confirm a third communication type through exclusion. The following provides detailed description by mainly using two communication types, namely, the downlink communication and the idle communication type, as an example and with reference to the accompanying drawings.

Before the embodiments of the present invention are described in detail, a wireless communications system that may be used in the embodiments of the present invention is first described with reference to the accompanying drawings. Although a wireless communications system in which a flexible duplex technology is used as an example, a person skilled in the art should know that the embodiments of the present invention are applicable not only to such a wireless communications system, but also to another wireless communications system with a similar interference problem.

A terminal device in the embodiments of the present invention may be user equipment (UE), a handheld terminal, a communications node on a household appliance, a medical device, an industrial device, an agricultural device, an aeronautical device, or the like, or may be a similar device such as a communications node used for device-to-device (device to device, D2D) communication. The D2D communication may be point-to-point communication, point-to-multipoint group communication, public security communication, or the like.

A network device in the embodiments of the present invention may be a macro base station, a micro base station, a controller, a relay node, a mobility management entity (MME), a communications node used for D2D communication, or the like, or may be another similar network device.

In the following example, a wireless communications system includes a first network device and a second network device. There is a first terminal device in a cell managed by the first network device, and there is a second terminal device in a cell managed by the second network device.

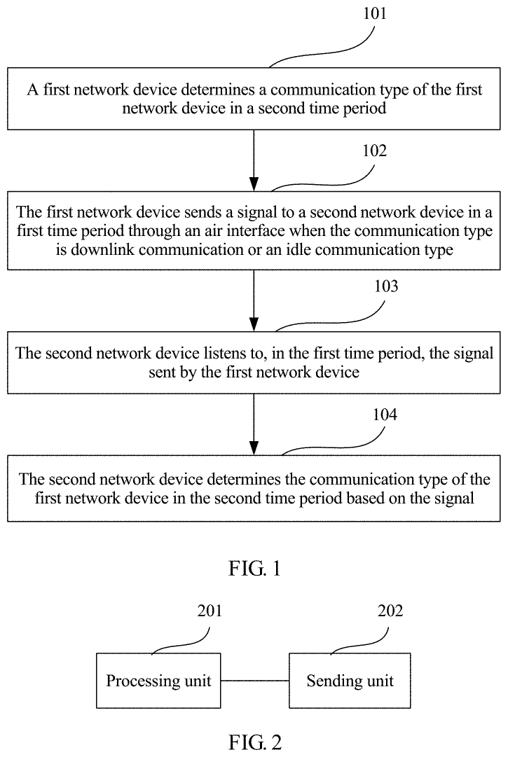

Based on the wireless communications system, as shown in FIG. 1, this embodiment includes the following operations.

Operation 101: The first network device determines a communication type of the first network device in a second time period.

The second time period may include one subframe, one slot, one mini-slot, or one symbol. Alternatively, the second time period may include a plurality of subframes, a plurality of slots, a plurality of mini-slots, or a plurality of symbols.

When the second time period includes a plurality of slots, the plurality of slots may be continuous or discontinuous in time. Further, when the second time period includes a plurality of slots, the communication type of the first network device in the second time period should be understood as a communication type of the first network device in each of the plurality of slots included in the second time period. In addition, communication types of the first network device in the plurality of slots may be the same or different.

In a TDD mode, that is, for a wireless communications system in which an unpaired operating frequency band is used, the communication type is a communication type of the first network device on a carrier on which the unpaired operating frequency band is used. In an FDD mode, that is, for a wireless communications system in which paired operating frequency bands are used, the communication type is a communication type of the first network device on a carrier on which one of the paired operating frequency bands is used. The communication type may be uplink communication, downlink communication, or an idle communication type.

Operation 102: The first network device sends a signal to the second network device in a first time period through an air interface when the communication type is downlink communication or an idle communication type, where the signal is used to indicate the communication type of the first network device in the second time period.

In the first time period, several subframes in one frame may be used as low-priority subframes, and the first symbol of each low-priority subframe is used as the first time period.

The first time period may be before the second time period. In addition, the two time periods may be in a same subframe, slot, or mini-slot.

The signal may include indication information. The indication information may be N-bit information, where N is a positive integer. For example, the indication information is 1-bit information. When a value of the indication information is 0, it indicates that the communication type is the downlink communication; or when a value of the indication information is 1, it indicates that the communication type is the idle communication type.

The signal may further include an identity of the first network device. When there are a plurality of first network devices, the second network device can determine, based on the identity, a communication type of each of the first network devices that are geographically relatively close to the second network device, and may further select a proper communication type based on statuses of the first network devices that are relatively close to the second network device, to avoid interference to these first network devices as much as possible. For example, three first network devices are relatively close to the second network device, and two first network devices are closer to the second network device. When determining a communication type of the second network device, the second network device may mainly consider communication types of the two first network devices that are closer to the second network device. Therefore, the communication type of each first network device needs to be determined based on an identity of the first network device.

Operation 103: The second network device listens to, in the first time period, the signal sent by the first network device.

Because the second network device needs to perform listening in the first time period, the second network device cannot exchange information with the second terminal device in the cell managed by the second network device. Therefore, the second network device may further send second indication information to the second terminal device, to instruct the second terminal device not to send and receive a signal in the first time period, thereby reducing complexity of the second terminal device. In addition, because a quantity of signals that need to be sent and received is reduced, power of the second terminal device is saved.

As described above, in the first time period, several subframes in one frame may be used as low-priority subframes, and the first symbol of each low-priority subframe is used as the first time period. The second network device needs to listen to, in the first symbol, the signal sent by the first network device. Therefore, the second terminal device does not need to send and receive a signal in the first symbol.

The second network device may send the second indication information to the second terminal device by using semi-static signaling such as RRC signaling. Alternatively, the second network device may send the second indication information by using dynamic signaling such as downlink control signaling.

Operation 104: The second network device determines the communication type of the first network device in the second time period based on the signal.

If the second network device does not receive the signal, it may be determined that the communication type of the first network device in the second time period is the uplink communication. If the signal is received, it may be determined, based on specific information in the signal, that the communication type is the downlink communication or the idle communication type.

Then, in addition to considering a service of the second network device in the second time period, the second network device needs to determine, based on the communication type of the first network device in the second time period, that the communication type of the second network device is the uplink communication or the downlink communication, to avoid causing interference to the uplink communication of the first network device, and avoid interference of the first network device to the second network device as much as possible. It should be noted that when the second network device is in an idle mode, communication of the first network device is not affected. Therefore, if the second network device has no service in the second time period, the second network device may be directly set to the idle mode without considering the communication type of the first network device.

For example, if the communication type of the first network device in the second time period is the uplink communication, in the second time period, the second network device determines that the communication type of the second network device may be the uplink communication, power-reduced downlink communication, or the idle communication type, to avoid interference to the uplink communication of the first network device.

If the communication type of the first network device in the second time period is the idle communication type, in the second time period, the second network device may determine, based on the service of the second network device in the second time period without considering interference between the two network devices, that the communication type of the second network device may be the uplink communication, the downlink communication, or the idle communication type.

If the communication type of the first network device in the second time period is the downlink communication, in the second time period, the second network device may determine, based on the service of the second network device in the second time period, that the communication type of the second network device may be the downlink communication or the idle communication type, to avoid interference of the downlink communication of the first network device to the second network device.

In the foregoing three cases, the second network device may select a specific communication type based on a service status of the second network device in the second time period.

For the first network device and the second network device, in a same time period, the first network device and the second network device may differ in communication type on a same frequency band. To be specific, the two network devices can support a flexible duplex technology.

In operation 104, after determining that the signal is not received, the second network device determines that the communication type of the first network device is the uplink communication. Further, before operation 104, some operations may be further added to help the second network device determine the communication type of the first network device.

Specifically, before operation 104, the following operations may be included:

Operation A: The first terminal device obtains information about communication types between the first network device and the first terminal device in the first time period and the second time period.

The first terminal device determines the communication types in a plurality of embodiments, for example, in a preset manner. Alternatively, the communication types may be determined by using indication information sent by the first network device. Correspondingly, in a solution in which the first network device sends the indication information, before operation A, the following operation may be further included:

Operation A′: The first network device determines the communication types between the first network device and the first terminal device in the first time period and the second time period, and sends the indication information to the first terminal device, to indicate the communication types.

The communication types may be the uplink communication or the downlink communication, or may be the idle communication type. The first terminal device needs to send an uplink signal only when the communication types are the uplink communication. Therefore, the first network device may alternatively send the indication information to the first terminal device only when the communication types are the uplink communication.

In one embodiment, the indication information may be 1-bit information. When a value of the indication information is 0, it indicates that the communication type is the downlink communication; or when a value of the indication information is 1, it indicates that the communication type is the idle communication type.

In this case, operation A includes: The first terminal device obtains the indication information.

Operation B: The first terminal device sends an uplink signal to the first network device in the first time period when both the communication types between the first network device and the terminal device in the first time period and the second time period are uplink communication.

If the indication information sent by the first network device is information about communication types, and the communication types include a plurality of types, for example, at least two of the uplink communication, the downlink communication, and the idle communication type, the first terminal device may specifically determine the communication types between the first network device and the terminal device in the first time period and the second time period based on the indication information, and determine whether the communication types are the uplink communication.

If the first network device sends the indication information only when the communication types are the uplink communication, when the first terminal device receives the indication information, it may indicate that the communication type of the first network device is the uplink communication. Therefore, after receiving the indication information, the first terminal device may send the uplink signal to the first network device in the first time period.

The terminal device sends the uplink signal in the first time period only when both the communication types in the two time periods are the uplink communication. Therefore, the first time period may be before the second time period, or may be a part of the second time period, for example, a start time of the second time period.

Operation C: The second network device listens to, in the first time period, the uplink signal sent by the first terminal device.

Correspondingly, in operation 104, if the second network device does not receive the signal from the first network device, but receives the uplink signal, it may be determined that the communication type of the first network device in the second time period is the uplink communication.

Alternatively, the foregoing solution in which the terminal device sends the uplink signal to the first network device, to help the second network device determine the communication type of the first network device may exist alone. To be specific, only the terminal device needs to send the uplink signal, and the first network device no longer sends, to the second network device, the signal used to indicate the communication type. Correspondingly, if the uplink signal is received, the second network device determines that the communication type of the first network device is the uplink communication. If the uplink signal is not received, it is determined that the communication type of the first network device is the downlink communication or the idle communication type.

In the foregoing solutions, network devices mutually transmit communication types through an air interface, and therefore a time period needs to be reserved for sending and receiving the communication types. In the reserved time period, the network devices cannot communicate with terminal devices in their respective coverage areas. Consequently, some time resources are wasted. There are usually many network devices in a wireless communications system. If each network device sends a communication type of the network device to other network devices, relatively high time resource overheads are required.

Correspondingly, there are two solutions that may minimize the time resource overheads.

In one solution, the first network device implicitly adds information about the communication type to another signal or information. In this solution, the first network device does not need to specifically reserve time for sending the communication type, but sends the information about the communication type to the second network device by using the another signal. Therefore, a time resource of the first network device can be saved. For example, the other signal is a pilot signal.

Specifically, the first network device may add the information about the communication type to a time-frequency pattern or sequence of the pilot signal. For example, a first pilot pattern represents the downlink communication, and a second pilot pattern represents the idle communication type. Alternatively, a first sequence represents the downlink communication, and a second sequence represents the idle communication type. Alternatively, the signal may be a control signal or a data signal. Specifically, the first network device may add the information about the communication type to a scrambling code of the control signal or the data signal. For example, a first scrambling code represents the downlink communication, and a second scrambling code represents the idle communication type.

In the other solution, network devices in a system are grouped, for example, grouped into two groups. A first group of network devices have a higher priority, and may determine communication types based on statuses of the first group of network devices without considering another network device. To be specific, this group of network devices need to send the communication types of this group of network devices only to a second group of network devices, do not need to listen to communication types of the second group of network devices, and do not need to send the communication types to a network device in this group either. The second group of network devices have a lower priority, need to listen to a communication type of another network device, and determine the communication types of this group of network devices based on the communication type of the another network device. In one embodiment, the second group of network devices may also send the communication types of the second group of network devices to a network device in this group. In this embodiment, the first group of network devices only need to send the communication types, and do not need to reserve time for receiving a communication type sent by another network device. Therefore, a time resource can be saved. The second group of network devices may not send the communication types of the second group of network devices, and only listen to the communication types of the first group of network devices. Therefore, a time resource can also be saved. For sending a communication type, to save a time resource, the former embodiment in which information that carries a communication type is implicitly carried in another signal or information may be further used.

For grouping the network devices, these network devices may be network devices having a same function, and are grouped mainly based on a factor such as a geographical location in the system. For example, network devices that are geographically relatively far from each other are set as first network devices. In this grouping method, there is a relatively high path loss between the first network devices, and therefore interference caused by use of a flexible duplex technology between this group of network devices is greatly reduced. In addition, to ensure fairness between the network devices, a configuration manner such as polling may be used. For example, the network devices in the system are grouped into two or more groups, network devices in one or several groups are used as the first network devices in a time period, and a network device in another group is used as the first network device in a next time period.

Apparatuses corresponding to the foregoing method embodiment are described below with reference to the accompanying drawings.

As shown in FIG. 2, a first network device in an embodiment of this application may include a processing unit 201 and a sending unit 202. The sending unit 202 may be specifically configured to perform the information sending performed by the first network device in the foregoing method embodiment; and the processing unit 201 may be specifically configured to perform the processing, other than the information receiving and sending, performed by the first network device in the foregoing method embodiment.

For example, the processing unit 201 may be configured to determine a communication type of the network device in a second time period; and the sending unit 202 may be configured to send a signal to a second network device in a first time period through an air interface when the communication type is downlink communication or an idle communication type, where the signal is used to indicate the communication type.

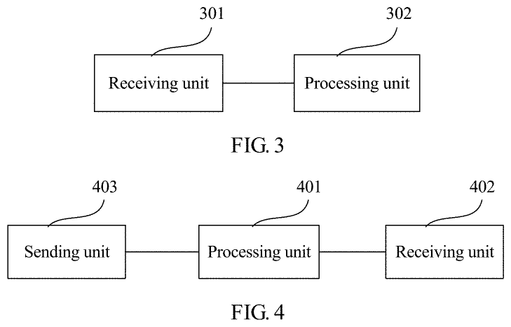

As shown in FIG. 3, a second network device in an embodiment of this application may include a receiving unit 301 and a processing unit 302. The receiving unit 301 may be specifically configured to perform the information receiving performed by the second network device in the foregoing method embodiment; and the processing unit 302 may be specifically configured to perform the processing, other than the information receiving and sending, performed by the second network device in the foregoing method embodiment.

For example, the receiving unit 301 may be configured to listen to, in a first time period through an air interface, a signal sent by a first network device, where the signal is used to indicate that a communication type of the first network device in a second time period is downlink communication or an idle communication type; and the processing unit 302 may be configured to: if the receiving unit receives the signal, determine, based on the signal, that the communication type of the first network device in the second time period is the downlink communication or the idle communication type.

As shown in FIG. 4, a terminal device in an embodiment of this application may include a processing unit 401 and a receiving unit 402, and may further include a sending unit 403. The processing unit 401 may be specifically configured to perform the processing, other than the information receiving and sending, performed by the terminal device in the foregoing method embodiment; the receiving unit 402 may be specifically configured to perform the information receiving performed by the terminal device in the foregoing method embodiment; and the sending unit 403 may be specifically configured to perform the information sending performed by the terminal device in the foregoing method embodiment.

For example, the receiving unit 402 may be configured to obtain information about communication types of a first network device and the terminal device in a first time period and a second time period; and the processing unit 402 sends an uplink signal to the first network device in the first time period by using the sending unit 403 when the communication type is uplink communication.

Detailed description and effects of the apparatus embodiment of this application are the same as those of the foregoing method embodiment. For brevity, details are not described again.

For the foregoing network device and terminal device, the processing unit, the sending unit, and the receiving unit may be a processor, a transmitter, and a receiver respectively.

A person of ordinary skill in the art may understand that some of the operations in the foregoing method implementations may be completed by a program executed by hardware. The program may be stored in a computer readable storage medium. When the program is executed, content of the implementations of an MIP technology-based communication method in the foregoing embodiments of the present invention may be performed. The storage medium described herein may be a ROM/RAM, a magnetic disk, an optical disk, or the like.

Although the embodiments of the present invention are illustrated and described with reference to some preferred embodiments of this application, a person of ordinary skill in the art should understand that various changes may be made to the embodiments in term of form and details without departing from the scope of this application.

What is claimed is:

1. An information transmission method for communicating information on communication types between network devices, comprising:
determining, by a first network device, a communication type of the first network device in a second time period; and
sending, by the first network device, a signal to a second network device in a first time period through an air interface when the communication type is a downlink communication type or an idle communication type, wherein the signal is used to indicate the communication type.

2. The method according to claim 1, wherein the determining, by a first network device, a communication type of the first network device in a second time period comprises:
determining, by the first network device, the communication type of the first network device in the second time period based on a service of the first network device in the second time period.

3. The method according to claim 1, further comprising:
sending, by the first network device, indication information to a terminal device, wherein
the indication information is used to indicate the communication type, or is used to indicate that the communication type is an uplink communication type in the first time period and in the second time period.

4. The method according to claim 1, wherein the first network device belongs to a first group of network devices, the second network device belongs to a second group of network devices, and wherein each network device in the first group of network devices sends information about a communication type of a respective network device only to the second group of network devices, and does not listen to information about a communication type of another network device.

5. A processing method for communicating information on communication types between network devices, comprising:
listening to, by a second network device in a first time period through an air interface, a signal sent by a first network device, wherein the signal is used to indicate that a communication type of the first network device in a second time period is a downlink communication type or an idle communication type; and
determining, in response to the second network receiving the signal, that the communication type of the first network device in the second time period is the downlink communication type or the idle communication type.

6. The method according to claim 5, further comprising:
determining, in response to the second network not receiving the signal, that the communication type of the first network device in the second time period is an uplink communication type.

7. The method according to claim 5, further comprising:
listening to, by the second network device in the first time period, an uplink signal sent by a terminal device managed by the first network device; and
determining, in response to the second network device not receiving the signal sent by the first network device, but receiving the uplink signal sent by the terminal device, that the communication type of the first network device in the second time period is an uplink communication type.

8. The method according to claim 5, further comprising:
determining, by the second network device, a communication type of the second network device in the second time period based on the determined communication type of the first network device in the second time period.

9. The method according to claim 5, wherein the signal is a pilot signal, a control signal, or a data signal.

10. The method according to claim 5, wherein the first network device belongs to a first group of network devices, the second network device belongs to a second group of network devices, and wherein the second group of network devices listen to information about communication types of the first group of network devices, and do not send information about communication types of the second group of network devices to the first group of network devices.

11. The method according to claim 5, wherein in a same time period, the first network device and the second network device differ in communication types on a same frequency band.

12. The method according to claim 5, wherein the first time period is before the second time period, or the second time period comprises the first time period, and the first time period is a start time of the second time period.

13. An apparatus of a second network device, comprising:
a receiving unit, configured to listen to, in a first time period through an air interface, a signal sent by a first network device, wherein the signal is used to indicate that a communication type of the first network device in a second time period is a downlink communication type or an idle communication type; and
a processing unit, configured to determine, based on the receiving unit receiving the signal, that the communication type of the first network device in the second time period is the downlink communication type or the idle communication type.

14. The apparatus according to claim 13, wherein
the processing unit is further configured to determine, based on the receiving unit not receiving the signal, that the communication type of the first network device in the second time period is an uplink communication type.

15. The apparatus according to claim 13, wherein
the receiving unit is further configured to listen to, in the first time period, an uplink signal sent by a terminal device managed by the first network device; and
the processing unit is further configured to determine, based on the receiving unit not receiving the signal sent by the first network device, but receiving the uplink signal sent by the terminal device, that the communication type of the first network device in the second time period is an uplink communication type.

16. The apparatus according to claim 13, wherein
the processing unit is further configured to determine a communication type of the second network device in the second time period based on the determined communication type of the first network device in the second time period.

17. The apparatus according to claim 13, wherein the signal is a pilot signal, a control signal, or a data signal.

18. The apparatus according to claim 13, wherein the first network device belongs to a first group of network devices, and wherein the receiving unit is further configured to listen to information about communication types of the first group of network devices, but do not send information about communication types of the second network device to the first group of network devices.

19. The apparatus according to claim 13, wherein in a same time period, the first network device and the second network device differ in communication types on a same frequency band.

20. The apparatus according to claim 13, wherein the first time period is before the second time period, or the second time period comprises the first time period, and the first time period is a start time of the second time period.
